(19) United States
(12) Patent Application Publication
(10) Pub. No.: US 2019/0319697 A1
(43) Pub. Date: Oct. 17, 2019

(54) METHOD FOR TRANSMITTING A SIGNAL BY A TRANSMITTER DEVICE TO A NON-GEOSYNCHRONOUS SATELLITE

(71) Applicant: SIGFOX, Labege (FR)

(72) Inventors: David FERNANDEZ, Toulouse (FR); Christophe FOURTET, Pompignan (FR)

(21) Appl. No.: 16/347,780

(22) PCT Filed: Nov. 7, 2017
(86) PCT No.: PCT/EP2017/078495

§ 371 Date: May 6, 2019

(30) Foreign Application Priority Data
Nov. 8, 2016 (FR) 1660762

(51) Int. Cl. H04B 7/185; G01S 5/02; G01S 19/29

(52) U.S. Cl. CPC H04B 7/18552; G01S 19/29; G01S 5/02

(57) ABSTRACT

A method for transmitting a signal by a transmitter device to a satellite moving in orbit around the Earth, the transmitter device and the satellite including wireless telecommunication means. The method includes the following steps: receiving, by the transmitter device, a signal transmitted by the satellite, referred to as a presence signal, analyzing a frequency shift caused by Doppler effect on a main frequency of the presence signal received by the device, evaluating a proximity criterion between the transmitter device and the satellite on the basis of the analysis of the frequency shift, and transmitting a signal by the transmitter device if the proximity criterion is met.

### CROSS REFERENCE TO RELATED APPLICATIONS

This application is a National Stage of International Application No. PCT/EP2017/078495, having an International Filing Date of 7 Nov. 2017, which designated the United States of America, and which International Application was published under PCT Article 21(2) as WO Publication No. 2018/087095 A1, which claims priority from and the benefit of French Patent Application No. 1660762, filed on 8 Nov. 2016, the disclosures of which are incorporated herein by reference in their entireties.

### BACKGROUND

### 1. Field

The present disclosure belongs to the field of wireless telecommunication systems and more particularly relates to a method for transmitting a signal between at least one emitting device and at least one satellite moving in orbit.

The present disclosure is in particular applicable to the field of connected objects.

### 2. Brief Description of Related Developments

One particularly advantageous, although completely non-limiting, application of the present disclosure is to UNB (ultra-narrow band) wireless telecommunication systems. By “ultra-narrow band” what is meant is that the instantaneous frequency spectrum of the electromagnetic signals transmitted by an emitting device, to a satellite, is of a frequency width smaller than two kilohertz, or even smaller than one kilohertz.

Such UNB wireless telecommunication systems are particularly suitable for M2M (machine-to-machine) or IoT (Internet of things) type applications.

It will be noted that the lifetime of emitting devices of this type of telecommunication system may reach about twenty years, provided that the emitting device does not emit signals needlessly, in particular signals intended for a satellite out of the range of said emitting device.

To this end, there are, in the prior art, techniques that allow an emitting device to detect the presence of a satellite emitting a signal of a given power at regular intervals. The detection is carried out on the basis of the power of the signal received by the emitting device, this allowing the propagation distance of the signal between the satellite and the emitting device to be approximately deduced therefrom.

The major drawback of these techniques is that they do not allow a precise determination of periods propitious to the transmission of signals to the satellite, i.e. when the satellite is at its closest to the emitting device. Specifically, the distance between the satellite and the emitting device not being a known datum, the periods propitious to the transmissions are calculated on the basis of variations in the estimated distance between the satellite and the emitting device. However, since the propagation of the signal has a tendency to fluctuate unexpectedly, these variations result in transmissions that are ineffective, in particular when the satellite is not in range of the emitting device.

### SUMMARY

The objective of the present disclosure is to remedy all or some of the limitations of the prior-art solutions, in particular those described above, by providing a solution allowing at least one period propitious to the emission of one or more signals from an emitting device communicating to a satellite moving in orbit to be determined.

To this end, and according to a first aspect, the present disclosure relates to a method for transmitting a signal with an emitting device to a satellite moving in orbit about the Earth, said emitting device and the satellite comprising wireless telecommunication means, the method comprising the following steps:

receiving with said emitting device a signal emitted by the satellite, called the presence signal;

analyzing a frequency shift induced by Doppler effect in the presence signal received by said emitting device;

evaluating a proximity criterion quantifying the proximity between said emitting device and said satellite, on the basis of the analysis of the frequency shift;

emitting a signal with said emitting device if the proximity criterion is met.

Thus, the emission of the signal by the emitting device is carried out when the proximity criterion is met. The proximity criterion in particular allows a period propitious to the emission of the signal, corresponding to the moment at which the satellite is close to the emitting device, to be determined.

The Doppler effect induces a frequency shift in the presence signal during its transmission to the emitting device. The Doppler effect is dependent on the velocity of the satellite, on the velocity of the emitting device, on the angle between the velocity vector of the satellite and the straight line formed by the satellite and the emitting device, and on the angle between the velocity vector of the emitting device and said straight line. In other words, the Doppler effect is dependent on the angle between the direction of relative movement of the emitting device and the satellite emitting the presence signal and the straight line connecting the emitting device and the satellite, this straight line corresponding to the direction of propagation of the presence signal between the emitting device and the satellite.

By analyzing the frequency shift induced by the Doppler effect, it is possible to determine whether the satellite is in the process of moving toward or moving away from the emitting device. Moreover, it should be noted that when the satellite is at its closest to the emitting device, the frequency shift induced by Doppler effect drops to zero.

By emitting device what is meant is any object equipped with a telecommunication means able to emit a signal. The emitting device may for example be a connected object. By connected object what is meant is any apparatus that is connected to a computer network for exchanging data such as the Internet, and that is remotely controllable or interrogatable. The connected object may be of any type. It may for example be a weather station collecting data on the temperature inside and outside a dwelling, a sensor for measuring the level of a liquid or gas in a cistern or a tank, a detector of occupation of a parking space, a sensor for measuring the number of people entering a building, etc. The connected object may also be a base for relaying data between a connected apparatus and a network. This relaying base may play the role of a repeater or of a buffer storing data to be transmitted to the network in a computer memory of the relaying base.

In particular implementations, the transmitting method may furthermore comprise one or more of the following features, applied individually or in any technically possible combination.

In particular implementations, the step of analyzing the frequency shift comprises a substep of measuring a main frequency of the presence signal and a substep of estimating the frequency shift induced by Doppler effect depending on the measured main frequency and on a theoretical main frequency of said presence signal.

It should be noted that the main frequency of the presence signal is for example representative of the frequency of a carrier of said presence signal, or even of the frequency of a sub-carrier of said presence signal, of a central frequency of an instantaneous frequency spectrum of said presence signal, of a minimum or maximum frequency of said instantaneous frequency spectrum, etc.

Thus, the signal may be emitted by the emitting device when the satellite is at its closest to the emitting device, whether the satellite is flying over the emitting device or not. Specifically, the theoretical main frequency corresponds to the main frequency with which the presence signal was emitted by the satellite, so that the frequency shift induced by Doppler effect may be estimated by calculating the difference between the measured main frequency and the theoretical main frequency. When the frequency shift thus estimated is close to zero, this means that the satellite is close to said emitting device.

In particular implementations, the step of evaluating the proximity criterion comprises a substep of comparing the estimated frequency shift with a threshold value.

The threshold value, which could also be called the proximity threshold, makes it possible for the emitting device to determine whether or not it should transmit a signal to the satellite.

In particular implementations, the step of analyzing the frequency shift comprises a substep of estimating a variation as a function of time in the frequency shift induced by Doppler effect on the basis of an evaluation of a variation as a function of time in the main frequency of the presence signal between at least two different respective times.

Thus, the proximity of the satellite may be determined on the basis of an approximation of the derivative of a curve as a function of time of the main frequency of the presence signal received by said emitting device. It should be noted that the variation as a function of time in the main frequency is generally similar to the variation as a function of time in the frequency shift, in particular when the presence signal is emitted with a main frequency that is constant over time. The variation as a function of time in the main frequency may be measured directly by measuring the difference between the main frequency at two different respective times or indirectly by measuring the main frequency at at least two different respective times, and by calculating the difference between the measured main frequencies.

In particular implementations, the step of evaluating the proximity criterion comprises a substep of comparing the estimated variation as a function of time in the frequency shift with a threshold value.

In particular implementations, the presence signal emitted by the satellite comprises at least one modulated sub-carrier with a preset frequency difference with respect to a carrier frequency of said presence signal.

Thus, the presence signal may be easily identified among a multitude of received signals.

In particular implementations, the step of receiving the presence signal comprises a substep of detecting the presence signal depending on said frequency difference.

In particular implementations, the detecting substep is carried out by way of a super-regenerative receiver.

In particular implementations, the analysis of the frequency shift induced by Doppler effect in the presence signal comprises a step of measuring a main frequency or a variation as a function of time in a main frequency, carried out by way of a phase-locked loop.

In particular implementations, the method furthermore comprises a step in which the proximity criterion is dynamically adjusted by the emitting device depending on adjustment information received in a signal emitted by the satellite.

Thus, the proximity threshold may be dynamically determined depending on the payload of the satellite and communicated to emitting devices located in the field of the satellite. The value of the proximity threshold may thus be common to a plurality of emitting devices, or differ between two emitting devices, different values of the value of the threshold for example being coded in two different channels.

In particular implementations, the adjustment information is determined, by the satellite, depending on the number of signals received by said satellite in a preset period.

Thus, the dynamic adjustment allows the coverage, also called the swath, of the satellite, to be adjusted.

According to a second aspect, the present disclosure relates to an emitting device of a wireless telecommunication system, implementing a transmitting method according to any one of the implementations of the present disclosure.

In particular embodiments, the emitting device is a connected object.

According to a third aspect, the present disclosure relates to a wireless telecommunication system comprising at least one emitting device according to any one of the embodiments of the present disclosure and at least one satellite moving in orbit about the Earth.

### BRIEF DESCRIPTION OF THE DRAWINGS

The present disclosure will be better understood on reading the following description, which is given by way of completely nonlimiting example, with reference to the figures, which show:

FIG. 1: a schematic representation of an example of an embodiment of a telecommunication system,

FIG. 2: curves illustrating variations in the frequency shift as a function of the position of a satellite relative to an emitting device of the telecommunication system of FIG. 1,

FIG. 3: a flowchart illustrating an example of an implementation of a method for transmitting a signal with an emitting device to a satellite,

FIG. 4: two curves illustrating processing carried out to detect a presence signal emitted by the satellite,

FIG. 5: a curve illustrating an example of a frequency shift in a signal as a function of time.

In these figures, identical references have been used to reference elements that are identical or analogous. For the sake of clarity, the elements have not been drawn to scale unless otherwise indicated.

### DETAILED DESCRIPTION

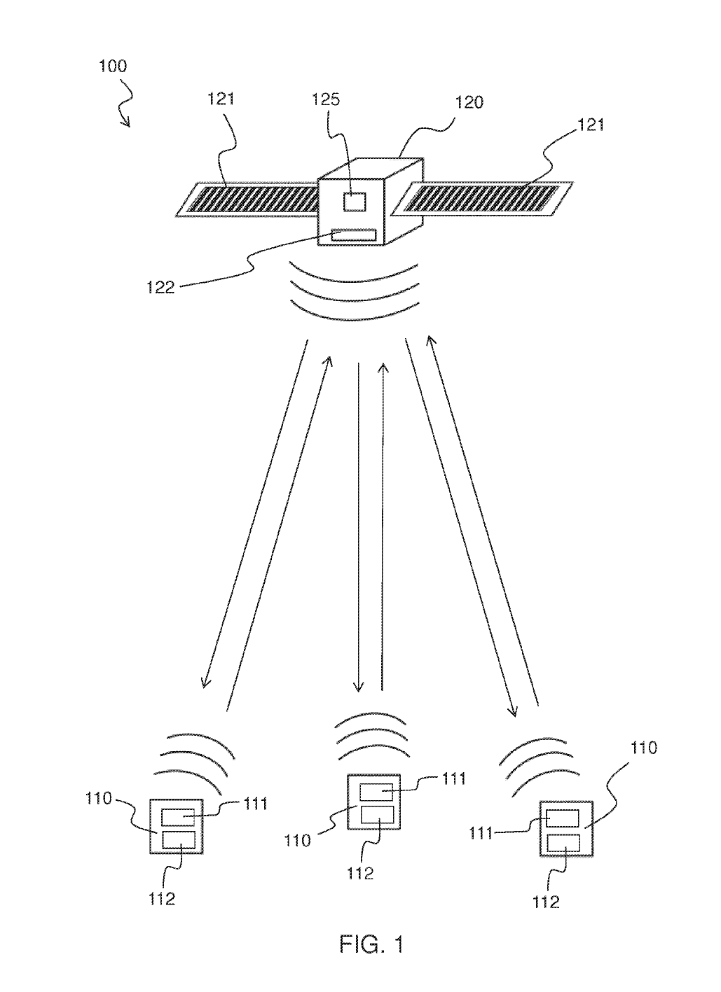

FIG. 1 schematically shows a wireless telecommunication system 100 comprising a plurality of emitting devices 110 and a satellite 120 of a constellation of nanosatellites previously placed in orbit around the Earth.

The emitting devices 110 and the satellite 120 exchange data in the form of electromagnetic signals. By “electromagnetic signal”, what is meant is an electromagnetic wave that propagates via non-wired means, and the frequencies of which are comprised in the conventional spectrum of electromagnetic waves (i.e. a few hertz to several hundred gigahertz).

The emitting devices 110 are, in the present nonlimiting example of the present disclosure, connected objects comprising telecommunication means 111 able to transmit signals to the satellite 120. It should be noted that the objects 110 may also, in particular embodiments, exchange signals between one another.

For example, the connected objects 110 furthermore comprise an electronic board 112 equipped with a microprocessor able to process data, or even a computer memory able to store data before they are transmitted via signals.

The signals transmitted by the emitting devices 110, and/or the signals transmitted by the satellite 120, are for example UNB (ultra-narrow band) signals.

The UNB signals exchanged within the telecommunication system 100 comprise a carrier the frequency of which is about 100 MHz, or even about 1 GHz. The bandwidth of the UNB signals is narrower than 2 kHz, or even narrower than 1 kHz.

The telecommunication means 111 connected to the electronic board 112 of said connected object 110 comprise in the present nonlimiting example of the present disclosure an antenna able to transmit and receive UNB signals, a phase-locked loop and a super-regenerative receiver.

The satellite 120 is, in the present example, a nanosatellite of the CubeSat type formed by a cubic structure of ten-centimeter side length. Two photovoltaic panels 121 deployed on either side of the cubic structure supply the satellite 120 with power. The mass of the satellite 120 is substantially equal to five kilos. An antenna 122 directed toward the Earth's surface allows UNB signals to be transmitted to or received from the connected objects 110. It should be noted that the satellite 120 is placed in an orbit at about five-hundred kilometers from the Earth. The satellite 120 thus moves around the Earth at a speed of about seven kilometers per second, and makes a complete orbit about the planet in a time of about ninety minutes. Generally, the satellite 120 is in a non-geosynchronous orbit, for example in an LEO (ow Earth orbit) or an MEO (medium Earth orbit).

The satellite 120 furthermore comprises a beacon 125 that continuously emits a UNB signal, called the presence signal below. The presence signal emitted by the beacon 125 for example comprises a carrier the frequency of which, at the moment of emission, is for example substantially constant over time.

In one variant of this particular embodiment of the present disclosure, the beacon 125 discontinuously emits presence signals, preferably at regular intervals. The emitted presence signals are for example of limited duration, for example comprised between a few hundred milliseconds and a few seconds.

It should be noted that, to save energy, the connected object 110 is generally in standby mode most of the time and that it exits from this standby mode at regular intervals in order to listen for and/or transmit signals.

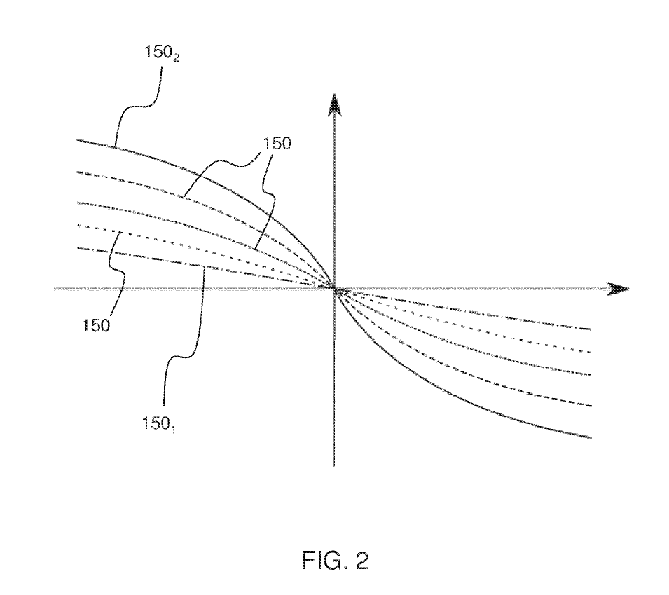

FIG. 2 shows an example of curves 150 of the variation in the frequency shift in signals received by a connected object 110 from the satellite 120 as a function of the position of the satellite with respect to the connected object. FIG. 2 comprises five curves each of which corresponds to a different maximum angle of elevation of the satellite 120 seen by the connected object 110. By maximum angle of elevation, also referred to as cross-track angle, what is meant is the angle between the ground and the direction of the satellite 120, measured at the object when the satellite 120 is at its closest to the connected object 110. The x-axis of the curves 150 corresponds to the difference between the latitude of the satellite 110 and the latitude of the connected object 110. When the maximum angle of elevation is small, as in the case of the curve 150₁, the satellite 120 is seen by the connected object 110 as being close to the horizon, whereas when the maximum angle of elevation is about ninety degrees, as in the case of the curve 150₂, the connected object 110 is located substantially plumb with the trajectory of the satellite 120.

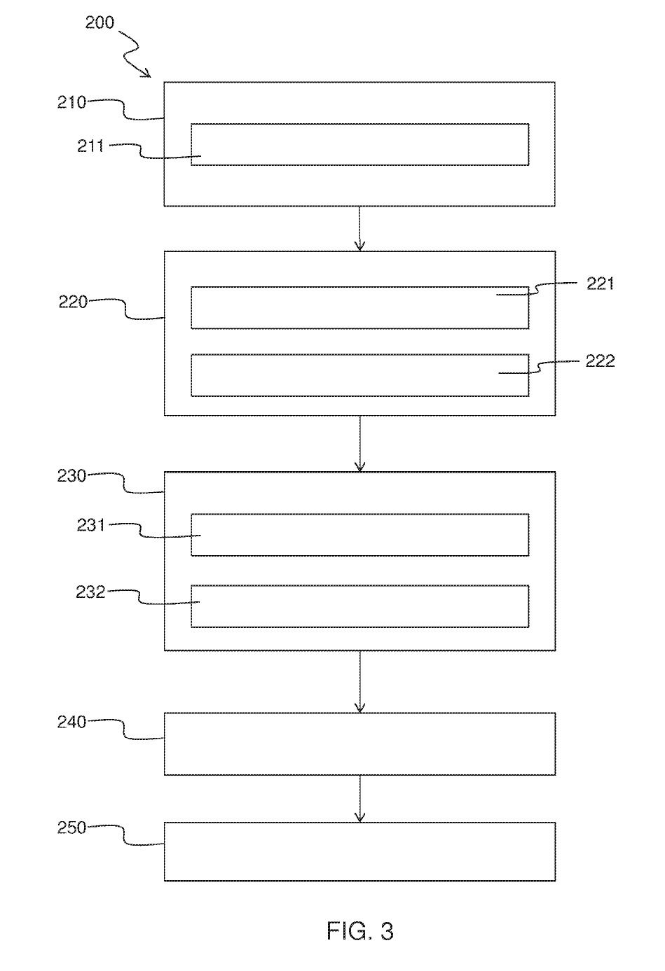

FIG. 3 shows in the form of a flowchart a method 200 for transmitting a signal between one of the connected objects 110 and the satellite 120 moving in orbit.

The method 200 comprises a step 210 in which the connected object 110 receives the presence signal emitted by the satellite 120.

In preferred implementations, the presence signal comprises a carrier of frequency f_{c_sat} and at least one modulated sub-carrier having a preset frequency difference fₛ with respect to the frequency f_{c_sat} in order to make it possible to differentiate between signals coming from the beacons and signals coming from the connected objects 110, which signals do not have this particular form or, in the contrary case, have a preset frequency different from the frequency difference fₛ of the presence signal.

In other words, the presence signal of the satellite 120 contains information allowing the origin of the presence signal to be identified, i.e. in the present case the beacon 125 of the satellite 120, via the presence of the modulated sub-carrier having a preset frequency difference fₛ with respect to the frequency f_{c_sat}. More generally, the identification information of the presence signal may be coded into the presence signal emitted by the beacon 125 using any technique known to those skilled in the art.

It should be noted that such a presence signal comprising a carrier and at least one sub-carrier is of self-timed type. The recognition of the presence signals by virtue of the presence of a sub-carrier having a preset frequency difference with respect to the carrier is advantageously used in the case of a hybrid telecommunication network comprising a plurality of connected objects and a plurality of satellites, in which type of network a connected object may receive signals originating both from a satellite and from another connected object.

Step 210 for example comprises a substep 211 of detecting the signal of the beacon 125 among a plurality of received signals. To this end, the super-regenerative receiver included in the connected object 110 allows the presence signal emitted by the beacon 125 to be detected by virtue of the presence of the sub-carrier in the presence signal, the frequency difference of which with respect to the carrier frequency of the presence signal is advantageously preset. It should be noted that the super-regenerative receiver advantageously has a very low power consumption of about one-hundred microwatts when actively receiving. The power consumption of the super-regenerative receiver may be decreased by employing cycles of recurrent non-contiguous detections. Increasing the latency between two consecutive detections in particular allows the power consumption of this receiver to be decreased.

Moreover, it should be noted that the super-regenerative receiver is advantageously insensitive to frequency variations if the carrier and the sub-carriers vary in a similar way, as is the case when the presence signal is affected by the Doppler effect.

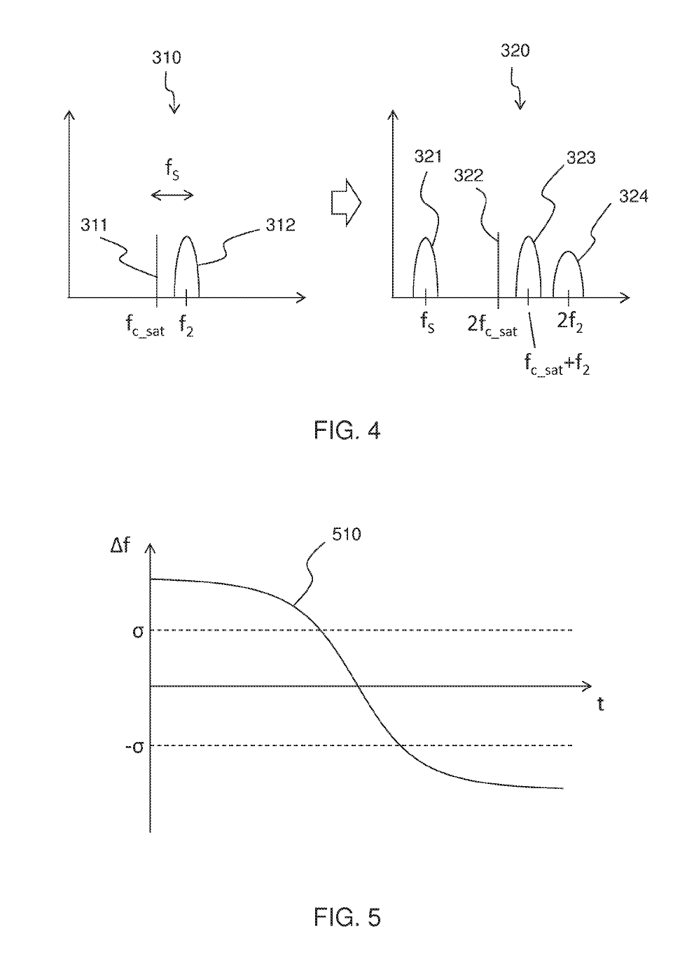

An example of a result obtained via this detection mechanism is illustrated in FIG. 4, which comprises a curve 310 before detection and a curve 320 after detection. The curve 310 comprises a carrier 311 of frequency f_{c_sat} and a modulated sub-carrier 312 of frequency f₂. The frequency difference between the carrier and the subcarrier is equal to fₛ. The detection allows a signal 321 of frequency fₛ, a signal 322 of frequency 2f_{c_sat}, a signal 323 of frequency f_{c_sat}+f₂ and a signal 324 of frequency 2f₂ to be extracted.

The frequency shift induced by Doppler effect in the presence signal received by the connected object 110 is analyzed in a step 220 of the method 200.

In this analyzing step 220, the variation as a function of time in a main frequency of the presence signal is for example evaluated in a substep 221. The main frequency in question for example corresponds to the frequency of the carrier of the presence signal.

In order to evaluate the variation as a function of time in the main frequency, the presence signal is for example duplicated into two replicas one of which is delayed by a set time, for example of about a few seconds. Simultaneous analysis of these two replicas, for example of the correlation of said two replicas, allows the variation as a function of time in the main frequency of the presence signal to be evaluated.

In one variant of this particular implementation of the present disclosure, the variation as a function of time in the main frequency may be calculated on the basis of a measurement of the main frequency at at least two different respective times.

It should be noted that the variation as a function of time in the main frequency, which corresponds in the present example to the carrier frequency of the presence signal, is for example analyzed using a synchronous detection mechanism similar to that of a phase-locked loop or a lock-in amplifier. The phase-locked loop in particular allows measurements of frequency or of the phase shift between two signals to be carried out. During this analysis, the super-regenerative receiver may advantageously use its absolute local reference oscillator. The variation as a function of time in the frequency shift induced by Doppler effect is then estimated in a substep 222. Given that the presence signal is emitted with a main frequency that remains constant over time, the variation as a function of time in the frequency shift induced by Doppler effect is equal to the variation as a function of time in the main frequency.

In particular implementations of the analyzing step 220, which may be used as alternatives to or to complement the implementations described above, the frequency shift induced by Doppler effect may be estimated on the basis of a measurement of the main frequency of the presence signal. For example, the measured main frequency of the presence signal is compared to a theoretical main frequency of the present signal, which corresponds to the frequency of the carrier at the moment of emission of the presence signal by the beacon 125. The emission frequency of the carrier is in certain cases known beforehand, in which case the beacon 125 emits at a preset frequency for example corresponding to a previously established standard. When the emission frequency of the carrier is not known, the value of said emission frequency may for example be coded into the presence signal, and for example modulates the modulated subcarrier of said present signal.

The method 200 then comprises a third step 230 of evaluating a proximity criterion depending on the result of the analysis of the frequency shift carried out in the analyzing step 220.

Generally, the evaluation of the proximity criterion aims to determine the period propitious to the trigger of the emission of the signal by the connected object 110, and the choice of one particular proximity criterion is merely one variant of implementation of the present disclosure.

The evaluated proximity criterion depends on the type of analysis of the frequency shift induced by Doppler effect in the present signal. Thus, if the analysis carried out results in an estimate of the variation as a function of time in the frequency shift, then the evaluation of the proximity criterion uses the estimated variation as a function of time in said frequency shift; if the analysis carried out results in an estimate of the frequency shift, then the evaluation of the proximity criterion uses the estimated frequency shift, etc.

In the rest of the description, the case considered, nonlimitingly, is the case where the analyzing step 220 comprises both estimating the frequency shift and estimating the variation as a function of time in said frequency shift, and where the evaluation of the proximity criterion uses both the estimated frequency shift and the estimated variation as a function of time in said frequency shift. The proximity criterion is for example considered to be met if at least one among the following conditions is met: a first condition relating to the value of the frequency shift induced by Doppler effect in the main frequency of the present signal and a second condition relating to the variation as a function of time in this frequency shift. Alternatively, the proximity criterion may be considered to be met if both the first condition and the second condition are met.

The frequency shift estimated in step 220 is compared, in a substep 231, with a preset threshold value, called the proximity threshold.

An example of a curve 510 of the variation in the estimated frequency shift Af is shown in FIG. 5. Thus, if the estimated frequency shift is lower in absolute value than the proximity threshold (σ in FIG. 5), the satellite 120 is considered to be within range of the connected object 110 and the first condition is met.

It should be noted that if the maximum angle of elevation of the satellite 120 is small, i.e. when the satellite 120 is seen by the connected object 110 as being on the horizon, the curve of the frequency shift may most of the time be below the threshold value. In this case, it is possible that the signal received from the connected object 110 by the satellite 120 will be of low power.

Therefore, in order to improve the transmission of signals from the connected objects 110 to the satellite 120, the second proximity-criterion condition may advantageously be used alone or in combination with the first condition evaluated in substep 231. The second condition is for example considered to be met when the estimated variation as a function of time in the measured carrier frequency of the present signal is greater than a second preset threshold value. In other words, the second condition is met when the estimated variation as a function of time in the frequency shift induced by Doppler effect is greater than the second threshold value. The second proximity-criterion condition thus relates to the slope of the curve of the carrier frequency of the present signal, or to the curve of the frequency shift, which is similar.

To this end, the variation as a function of time in the frequency shift is compared with the second threshold value in a substep 232. When the slope of the curve is in absolute value greater than a threshold value, the second condition is considered to be met. Such a proximity-criterion condition is advantageous in that it furthermore allows emission of a signal by the connected object to be limited to a range, about 90°, of particular values of the maximum angle of elevation.

Such as indicated above, the proximity criterion is for example considered to be met if the first condition and/or second condition are/is met. When the proximity criterion is met, the connected object 110 may transmit a signal to the satellite 120 in step 240 in which the connected object 110 emits the signal. In the contrary case, i.e. when the proximity criterion is not met, the connected object 110 does not transmit any signal to the satellite 120.

More generally, and such as indicated above, the choice of one particular proximity criterion, and therefore of one or more conditions that must be met in order for the proximity criterion to be considered to have been met, is merely one variant of implementation of the present disclosure. For example, it is possible to require one or more of the following conditions to be met for the proximity criterion to be considered to have been met:
the estimated frequency shift or the absolute value of the estimated frequency shift must be lower than a threshold;
the estimated frequency shift must be lower in absolute value than one threshold and higher in absolute value than a second threshold;
the estimated frequency shift must be lower than one threshold and higher than a second threshold;
the estimated frequency shift or the absolute value of the estimated frequency shift must be higher than a threshold;
the estimated variation as a function of time in the frequency shift or the absolute value of the estimated variation as a function of time in the frequency shift must be higher than a threshold;
the estimated variation as a function of time in the frequency shift must be higher in absolute value than one threshold and lower in absolute value than a second threshold;
the estimated variation as a function of time in the frequency shift must be higher than one threshold and lower than a second threshold;
the estimated variation as a function of time in the frequency shift or the absolute value of the estimated variation as a function of time in the frequency shift must be lower than a threshold, etc.

Advantageously, the method 200 may also comprise a step 250 in which the connected object 110 dynamically adjusts the proximity criterion depending on adjustment information received in a signal emitted by the satellite 120. The adjustment information allows the value of the proximity threshold, of the first and/or second condition(s) allowing the proximity criterion to be evaluated by the connected object 110 to be adjusted.

It should be noted that the proximity criterion may be adjusted dynamically depending on the number of signals received by the satellite 120 in a preset period, or depending on the number of connected objects 110 having the satellite 120 in range. Moreover, the range of the satellite 120, corresponding to the maximum distance at which signals emitted by the satellite 120 may be received by a connected object 110, is generally different from the range of the connected object, corresponding to the maximum distance at which signals emitted by the connected object 110 may be received by the satellite 120. The range of the satellite 120, also called the down-link range, may be different from the range of the object, also called the up-link range.

In the present example, the power of the presence signals emitted by the beacon 125 is higher than the power of the signals emitted by the connected objects 110. Therefore, the range of the satellite is in principle greater than the range of the connected object 110.

In other words, adjustment of the proximity criterion allows the size of the coverage of the satellite 120, also called the swath of the satellite 120, to be adjusted by determining the number of connected objects 110 in range of the satellite 120 and able to transmit a signal to the satellite 120.

What is claimed is:

1. A method for transmitting a signal with an emitting device to a satellite moving in orbit about the Earth, said emitting device and the satellite comprising wireless telecommunication means, wherein said method comprises steps of:
receiving with said emitting device a signal emitted by the satellite, called the presence signal;
analyzing a frequency shift induced by Doppler effect in the presence signal received by said emitting device;
evaluating a proximity criterion quantifying the proximity between said emitting device and said satellite, on the basis of the analysis of the frequency shift; and
emitting a signal with said emitting device if the proximity criterion is met.

2. The method as claimed in claim 1, wherein the step of analyzing the frequency shift comprises a substep of measuring a main frequency of the presence signal and a substep of estimating the frequency shift induced by Doppler effect depending on the measured main frequency and on a theoretical main frequency of said presence signal.

3. The method as claimed in claim 2, wherein the step of evaluating the proximity criterion comprises a substep of comparing the estimated frequency shift with a threshold value.

4. The method as claimed in claim 1, wherein the step of analyzing the frequency shift comprises a substep of estimating a variation as a function of time in the frequency shift induced by Doppler effect on the basis of an evaluation of a variation as a function of time in the main frequency of the presence signal between at least two different respective times.

5. The method as claimed in claim 4, wherein the step of evaluating the proximity criterion comprises a substep of comparing the estimated variation as a function of time in the frequency shift with a threshold value.

6. The method as claimed in claim 1, wherein the presence signal emitted by the satellite comprises at least one modulated sub-carrier with a preset frequency difference with respect to a carrier frequency.

7. The method as claimed in claim 6, wherein the step of receiving the presence signal comprises a substep of detecting the presence signal depending on said frequency difference.

8. The method as claimed in claim 7, wherein the detecting substep is carried out by way of a super-regenerative receiver.

9. The method as claimed in claim 1, wherein the analysis of the frequency shift induced by Doppler effect in the presence signal comprises a step of measuring a main frequency of the presence signal or a variation as a function of time in said main frequency of said presence signal, carried out by way of a phase-locked loop.

10. The method as claimed in claim 1, wherein it furthermore comprises a step in which the proximity criterion is dynamically adjusted by the emitting device, depending on adjustment information received in a signal emitted by the satellite.

11. The method as claimed in claim 10, wherein the adjustment information is determined, by the satellite, depending on the number of signals received by said satellite in a preset period.

12. An emitting device of a wireless telecommunication system configured to implement the transmitting method as claimed in claim 1.

13. A wireless telecommunication system comprising at least one emitting device as claimed in claim 12, and at least one satellite moving in orbit about the Earth.
